(19) United States
(12) Patent Application Publication
(10) Pub. No.: US 2026/0277702 A1
(43) Pub. Date: Sep. 17, 2026

(54) PROCESSING RESOURCE SHARE ALLOCATION FOR A VIRTUAL COMPUTE ENTITY

(71) Applicant: Hewlett Packard Enterprise Development LP, Spring, TX (US)

(72) Inventor: Madhukesh Sambashivaiah, Bangalore Karnataka (IN)

(21) Appl. No.: 19/261,007

(22) Filed: Jul. 7, 2025

(30) Foreign Application Priority Data
Mar. 11, 2025 (IN) 202541022099

(51) Int. Cl. G06F 9/50

(52) U.S. Cl. CPC G06F 9/5077; G06F 9/5038

(57) ABSTRACT

In some examples, a system receives, from a virtual compute entity, a parameter indicative of how many virtual compute processes are in the virtual compute entity. The system generates a scheduling weight for the virtual compute entity based on a scheduling policy that considers the parameter, and the system allocates a share of a processing resource for the virtual compute entity based on the scheduling weight.

### BACKGROUND

An operating system (OS) in a computing system can include a scheduler that controls scheduling of processes for execution in the computing system. The scheduler uses a scheduling algorithm that attempts to provide a fair share of a processing resource to the processes, so that the processes can complete their operations without excessive delays.

### BRIEF DESCRIPTION OF THE DRAWINGS

Some implementations of the present disclosure are described with respect to the following figures.

FIG. 1 is a block diagram of a computing system according to some examples.

FIG. 2 is a flow diagram of a scheduling process according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Processes in a computing system may include virtual machines (VMs). For example, the computing system may include process 1 to process N (N≥2), where at least one of processes 1 to N is a VM. A scheduling algorithm applied by a scheduler of an operating system (OS) of the computing system may include a fair share algorithm in which respective processes 1 to N are allocated corresponding shares of a processing resource of the computing system. If multiple VM processes are run in the VM, then the processing resource share allocated to the VM may be inadequate and lead to reduced performance of the VM.

In a specific example, there are two processes including process 1 that is a non-VM process (e.g., process 1 may be a process of a program run outside of a VM), and process 2 that is a VM running M (M≥1) VM processes. If processes 1 and 2 are assigned the same scheduling weight, then the scheduler may allocate an equal processing resource share to each of process 1 and process 2 (e.g., a time slice assigned to process 1 for execution on the processing resource by the scheduler has the same duration as a time slice assigned to process 2). If there are more than one VM process in the VM, then that would mean the M VM processes of the VM have to contend for the processing resource share allocated by the scheduler. The VM processes of the VM are effectively given lower shares of the processing resource than process 1, which results in unfair assignment of processing resource shares to the VM processes. As the quantity of processes (including non-VM processes and VM processes) increases, the processing resource share (e.g., VM process time slice) allocated to each VM process decreases logarithmically, which can drastically reduce the performance of the VM processes. More generally, if a scheduler allocates processing resource shares to processes without considering quantities of VM processes that may be in VMs, then the VM processes may have to contend for inadequate allocations of processing resource shares that can cause reduced performance.

If the processing resource includes multiple physical processor cores, processor isolation can be implemented in which a VM when launched is pinned to a specific collection of physical processor cores (i.e., no other process can execute on the specific collection of physical processor cores). The collection of physical processor cores can include a single physical processor core or multiple physical processor cores. However, the quantity of physical processor cores in a computing system is finite, and processor isolation may not be feasible if a large quantity of VMs are executed in the computing system.

In accordance with some implementations of the present disclosure, a scheduler can allocate a fair share of a processing resource to a virtual compute entity that runs multiple virtual compute processes. The allocation of the processing resource share to the virtual compute entity is based on a parameter provided by the virtual compute entity representing how many virtual compute processes are in the virtual compute entity. The scheduler generates a scheduling weight for the virtual compute entity based on the parameter, and the scheduler allocates the processing resource share for the virtual compute entity based on the scheduling weight.

In some examples, the virtual compute entity is a VM that can run M (M≥1) VM processes. A virtual compute entity is created and managed by a virtual control entity in a computing system. For example, the virtual control entity may be a hypervisor that creates and manages VMs.

A scheduler according to some examples of the present disclosure can improve computer functionality by ensuring that virtual compute processes in virtual compute entities are allocated fair shares of a processing resource, to avoid starving or reducing a performance of a virtual compute entity.

More generally, the scheduler can allocate a fair share of a processing resource to a virtual compute entity according to a scheduling policy that considers multiple factors including the parameter representing how many virtual compute processes are in the virtual compute entity. Examples of other factors can include any or some combination of: priorities of processes (including one or more virtual compute entities and one or more processes that are not virtual compute entities, i.e., non-virtual compute processes), overall load of the processing resource, any service level agreement (SLA) assigned a tenant or other user that initiates the virtual compute entity, SLAs of other tenants or other users, carbon emissions, or other factors.

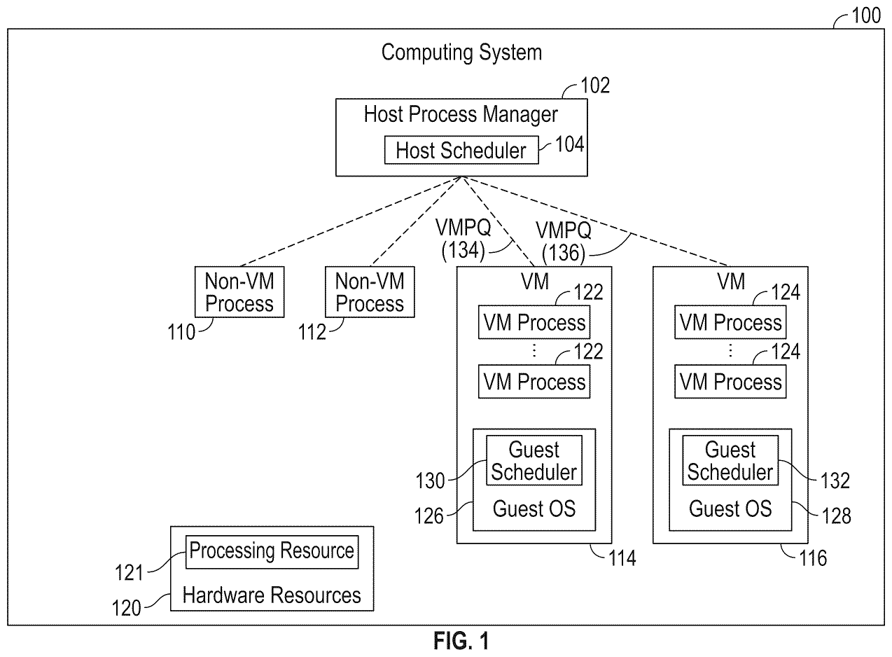

FIG. 1 is a block diagram of a computing system 100 that includes a host process manager 102 that can launch various processes in the computing system 100, including VMs and non-VM processes. The computing system 100 includes one or more computers. Although some examples of the present discussion refer to VMs, it is noted that in other examples, the host process manager 102 can launch other types of virtual compute entities as processes in the computing system 100.

In some examples, the host process manager 102 includes a host OS that can run as a hypervisor for the computing system 100. An example of such a host process manager 102 is a kernel-based VM (KVM). The KVM is an open source virtualization manager that includes a Linux OS. The Linux OS can function as a hypervisor that can launch VMs. The Linux OS can also launch non-VM processes, such as processes of application programs or other types of programs run outside a VM. In other examples, the host process manager 102 can include a host OS and a hypervisor, such as a Hyper-V hypervisor, an ESXi hypervisor, or another type of hypervisor.

The host process manager 102 includes a host scheduler 104, which may be part of the kernel of the host OS in the host process manager 102. In some examples, the host scheduler 104 may be a Completely Fair Scheduler (CFS) included in a Linux OS. Alternatively, the host scheduler 104 may implement a round-robin scheduling algorithm or any other type of scheduling algorithm.

The host scheduler 104 can schedule the execution of various processes in the host, which in the example of FIG. 1 is the computing system 100. The processes include non-VM processes 110 and 112 and VMs 114 and 116. A non-VM process refers to a process that is run outside of any VM. In other examples, the host scheduler 104 can schedule the execution of more than four processes or less than four processes.

The computing system 100 also includes hardware resources 120, such as a processing resource 121 and other resources. The other resources may include any or some combination of a memory, a persistent storage device, a network interface controller, an input/output (I/O) device, or any other type of hardware resource. The processes scheduled by the host scheduler 104 can use the hardware resources 120.

The host scheduler 104 assigns shares of the processing resource 121 to the processes scheduled by the host scheduler 104. The processing resource 121 can include any or some combination of: one or more central processing unit (CPUs), one or more graphics processing units (GPUs), one or more accelerators, or other types of processing resources.

In some examples, a share of the processing resource 121 assigned to a process by the host scheduler 104 can include a time slice during which the process is granted permission to run on the processing resource. Different processes are assigned different time slices. A first time slice allocated by the host scheduler 104 to a first process can be the same duration or a different duration than a second time slice allocated to a second process.

In other examples, instead of allocating time slices to processes, the host scheduler 104 can assign a share of the processing resource that includes a physical or logical segment of the processing resource. The processing resource can be divided into multiple segments (physical segments or logical segments), and a process can be allocated a subset of the processing resource segments.

The VM 114 includes various VM processes 122, and the VM 116 includes various VM processes 124. More generally, a VM can include one or more VM processes. A VM process is a process that is run within the context of a VM. The quantity of VM processes in one VM can be the same as or different from the quantity of VM processes in another VM.

Each VM also includes a guest OS to manage the execution of VM processes within the VM. For example, the VM 114 includes a guest OS 126, and the VM 116 includes a guest OS 128. The guest OS 126 includes a guest scheduler 130 that schedules the execution of the VM processes 122 within the VM 114. Similarly, the guest OS 128 includes a guest scheduler 132 that schedules the execution of the VM processes 124 within the VM 116.

If the host scheduler 104 grants processing resource shares to respective processes 110, 112, 114, and 116 without considering how many VM processes are run in each of the VMs 114 and 116, then the VMs 114 and 116 may not be allocated adequate processing resource shares to ensure that the VM processes in the VMs 114 and 116 can run successfully in a timely manner. In accordance with some examples of the present disclosure, each VM 114 or 116 can send a VM process quantity (VMPQ) parameter to the host scheduler 104. The guest OS 126 in the VM 114 can send a VMPQ parameter 134 to the host scheduler 104, and the guest OS 128 in the VM 116 can send a VMPQ parameter 136 to the host scheduler 104. A VMPQ parameter specifies how many VM processes are in a respective VM. The VMPQ parameter 134 specifies how many VM processes 122 are in the VM 114, and the VMPQ parameter 136 specifies how many VM processes 124 are in the VM 116.

A VM can provide a VMPQ parameter to the host scheduler 104 using any of various types of communication channels. For example, the communication channel can include a paravirtual channel between the guest OS in the VM and the hypervisor that is part of the host process manager 102.

Alternatively, the communication channel is created responsive to a system call in the VM that causes a privilege level transition in the VM. For example, when a new VM process is launched in a VM, the new VM process uses a system call that causes a privilege level transition that is handled in the host OS of the host process manager 102. In examples where the host OS is a Linux OS, the system call can include a fork( ) call or a clone( ) call. The fork( ) call is to create a new process, and the clone( ) call is to create a new child process. In response to the fork( ) or clone ( ) call, the guest OS in the VM sends a kick, which is a request for a privilege level change, to the hypervisor in the context of the host OS that is part of the host process manager 102. The kick is handled by the host OS.

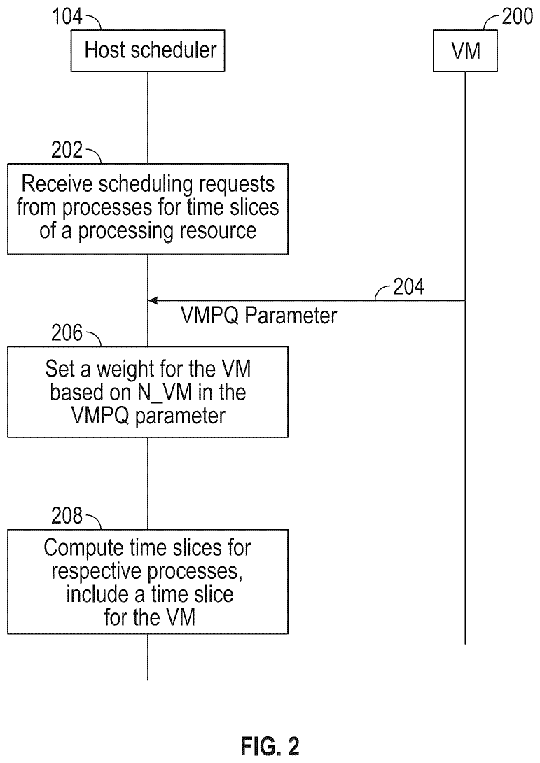

FIG. 2 is a flow diagram of a scheduling process that involves the host scheduler 104 and a VM 200, where the VM 200 can be the VM 114 or 116 of FIG. 1.

The host scheduler 104 receives (at 202) scheduling requests from processes for time slices of the processing resource 121. The scheduling requests can be received from non-VM processes and VMs, including the VM 200.

The guest OS in the VM 200 sends (at 204) a VMPQ parameter to the host scheduler 104. The VMPQ parameter specifies how many VM processes are in the VM 200. In some examples, the VMPQ parameter may be included as part of the scheduling request sent from the VM 200 to the host scheduler 104. In other examples, the VMPQ parameter may separately sent (i.e., not part of the scheduling request).

The host scheduler 104 schedules processes during a scheduling period, which is a time interval during which processes are allocated shares of the processing resource 121. The host scheduler 104 performs a new round of scheduling in each successive scheduling period.

A time slice of the processing resource 121 allocated to a process can be based on a weight assigned the process. Eq. 1 below computes a time slice, Time_Slice(i), to allocate process i in a scheduling period (Scheduling_Period), assuming each process is allocated an equal time slice of the processing resource 121.

$$Time\_Slice ( i ) = \frac{Scheduling\_Period}{NP} . \qquad ( Eq . 1 )$$

In Eq. 1, NP (NP≥1) represents the quantity of processes to be scheduled by the host scheduler 104 during Scheduling_Period, and i is selected from 1 to NP.

In further examples, weights may be assigned to respective processes, where different weights may cause different time slices (of different durations) to be allocated to the processes. In such further examples, Eq. 2 calculates the time slice, Time_Slice(i), to allocate process i in Scheduling_Period.

$$Time\_Slice ( i ) = Scheduling\_Period \cdot \frac{{w}_{i}}{{\sum }_{i = 1}^{NP} {w}_{i}} , \qquad ( Eq . 2 )$$

where wᵢ is the weight for process i.

In accordance with some examples of the present disclosure, the host scheduler 104 sets (at 206) the weight for a VM (e.g., the VM 200) based on a quantity of VM processes in the VM. In an example where process i is a VM, then the weight wᵢ(VM) computed for the VM is an adjusted weight derived by the host scheduler 104 as follows.

$${w}_{i} ( VM ) = {w}_{i \_ initial} ( VM ) \cdot Function ( N\_VM ) , \qquad ( Eq . 3 )$$

where w_{i_initial}(VM) is an initial weight for the VM, and Function (N_VM) produces an adjustment factor based on how many (N_VM, where N_VM≥1) VM processes are in the VM. N_VM is included in the VMPQ parameter.

In some examples, the function Function(N_VM) is a logarithmic function, such as a log₁₀ N_VM function. In further examples, a different logarithmic function can be used, such as log_{b} N_VM, where b is a positive integer. In other examples, other types of functions based on N_VM can be used.

Effectively, the adjustment factor increases the weight assigned to the VM from the initial weight, w_{i_initial}(VM), so that the VM would be assigned greater weights for use in deriving time slices of the processing resource 121 for the VM as the quantity, N_VM, of VM processes increases.

The host scheduler 104 computes (at 208) time slices for respective processes, including a time slice for the VM 200. For a process i that is a VM, the host scheduler 104 computes the time slice, Time_Slice(i), assigned to the VM based on wᵢ(VM), as follows:

$$Time\_Slice ( i ) = Scheduling\_Period \cdot \frac{{w}_{i} ( VM )}{{\sum }_{i = 1}^{NP} {w}_{i}} , \qquad ( Eq . 4 )$$

Each process is able to execute on the processing resource 121 during the time period defined by the time slice assigned to the process.

In some examples, it is assumed that each of the VM processes within a VM is assigned equal weight by the guest scheduler of the VM. In other examples, different VM processes within the VM may be assigned different weights by the guest scheduler. In such other examples, instead of or in addition to reporting the quantity, N_VM, of VM processes (as represented by the VMPQ parameter) from the guest OS of the VM to the host scheduler 104, the guest OS can send VM process weights w_{VM}_{_{process}}(j), j=1 to N_VM, of the respective VM processes in the VM to the host scheduler 104, including w_{VM}_{_{process}}(1), w_{VM}_{_{process}}(2), . . . , w_{VM}_{_{process}}(N_VM).

In such examples where process i is a VM, then the weight wᵢ(VM) computed for the VM is an adjusted weight derived by the host scheduler 104 as set forth in Eq. 5.

$${w}_{i} ( VM ) = {w}_{i \_ initial} ( VM ) \cdot Function ( {{\sum }_{j = 1}}^{N \_ VM} {w}_{{VM}_{process}} ( j ) ) , \qquad ( Eq . 5 )$$

In Eq. 5, the adjustment factor,

$$Function ( {\sum }_{j = 1}^{N \_ VM} {w}_{{VM}_{process}} ( j ) ) ,$$

is based on the sum of the VM process weights w_{VM}_{_{process}}(j) reported by the guest OS of the VM to the host scheduler 104.

In alternative examples, instead of reporting individual weights, w_{VM}_{_{process}}(j), j=1 to N_VM, to the host scheduler 104, the guest OS of the VM can instead report an aggregate VM weight, Aggregate_w_{VM}_{_{processes}}, to the host scheduler 104 for use in Eq. 5, where

$${Aggregate\_w}_{{VM}_{processes}} = {\sum }_{j = 1}^{N \_ VM} {w}_{{VM}_{process}} ( j ) .$$

In some examples, a guest OS in a VM may send update messages to the host scheduler 104 in response to changes affecting VM processes in the VM. The changes can include: (1) a change in the quantity of VM processes in the VM, and/or (2) a change in a weight assigned to any VM process in the VM.

In an example, the update message may have the following form: Update (N_VM), where N_VM has been modified to represent a changed quantity of VM processes in the VM. In another example, the update message may have the following form: Update (w_{VM}_{_{process}}(j), . . . ), where one or more updated VM process weights are included.

As a further example, the update message may have the following form: Update (Aggregate_w_{VM}_{_{processes}}), where the aggregate VM weight, Aggregate_w_{VM}_{_{processes'}} has been changed due to a change of one or more VM process weights.

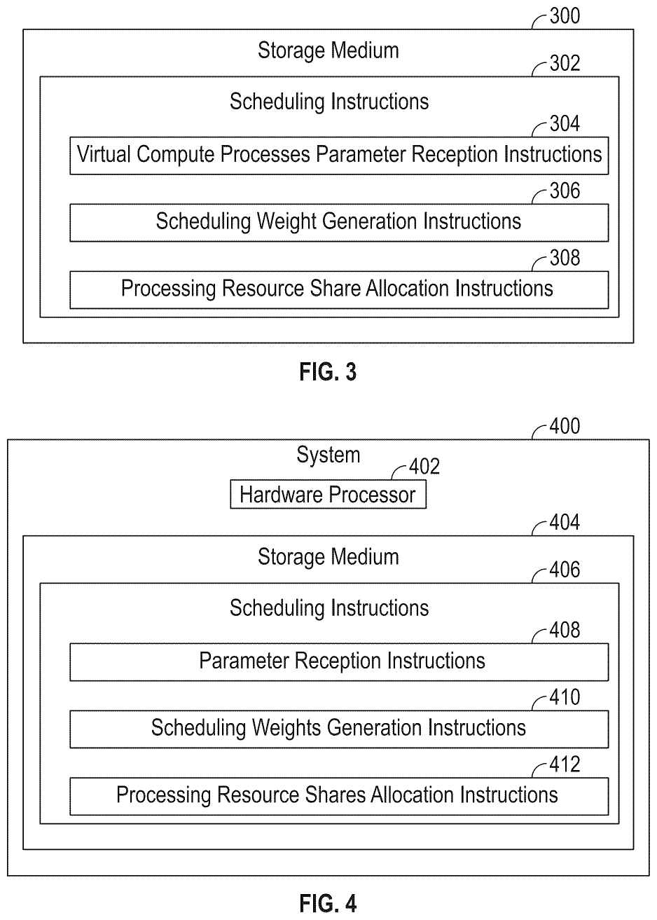

FIG. 3 is a block diagram of a non-transitory machine readable or computer-readable storage medium 300 storing scheduling instructions 302 that upon execution cause a system to perform various tasks. The scheduling instructions 302 are machine-readable instructions that may be part of the host scheduler 104 of FIG. 1, for example.

The scheduling instructions 302 include virtual compute processes parameter reception instructions 304 to receive, from a virtual compute entity, a parameter indicative of how many virtual compute processes are in the virtual compute entity. The virtual compute entity may be a VM, for example.

The scheduling instructions 302 include scheduling weight generation instructions 306 to generate a scheduling weight for the virtual compute entity based on a scheduling policy that considers the parameter and possibly one or more other factors (including those listed further above, for example). In an example, the scheduling weight for the virtual compute entity is based on the output of a function applied to the parameter (or more generally, a function that uses the parameter).

The scheduling instructions 302 include processing resource share allocation instructions 308 to allocate a share of a processing resource for the virtual compute entity based on the scheduling weight. For example, the share may be a time slice of the processing resource.

In some examples, the parameter is a count of how many virtual compute processes are in the virtual compute entity, such as a count of how many VM processes are in a VM.

In some examples, the parameter represents weights of the virtual compute processes in the virtual compute entity. For example, the parameter can include the weights of the virtual compute processes in the virtual compute entity, such as VM process weights w_{VM}_{_{process}}(j), j=1 to N_VM. In another example, the parameter can be an aggregate VM weight,

$${Aggregate\_w}_{{VM}_{processes}} = {\sum }_{j = 1}^{N \_ VM} {w}_{{VM}_{process}} ( j ) .$$

In some examples, the parameter is received from the virtual compute entity in a communication channel between the virtual compute entity and a host process manager including the scheduling instructions 302.

In some examples, the virtual compute entity includes a VM, and the host process manager includes a hypervisor. The communication channel can be a paravirtual channel. Alternatively, the communication channel is created responsive to a system call in the VM that triggers a privilege level transition in the VM.

In some examples, the parameter has a first value representing a first quantity of virtual compute processes in the virtual compute entity at a first time.

In some examples, the scheduling instructions 302 can receive, from the virtual compute entity, the parameter having a second value representing a second quantity of virtual compute processes in the virtual compute entity at a second time, the second value being different from the first value. The scheduling instructions 302 can generate a modified scheduling weight for the virtual compute entity based on the second value of the parameter, and allocate a modified share of the processing resource for the virtual compute entity based on the modified scheduling weight.

In some examples, the scheduling instructions 302 allocate a further share of the processing resource to a process that is not a virtual compute entity, wherein the further share of the processing resource allocated to the process does not consider how many sub-processes are associated with the process.

FIG. 4 is a block diagram of a system 400, which can be implemented with one or more computers. The system 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The system 400 includes a storage medium 404 storing scheduling instructions 406 executable on the hardware processor 402 to perform various tasks. Machine-readable instructions executable on a hardware processor can refer to the instructions executable on a single hardware processor or the instructions executable on multiple hardware processors.

The scheduling instructions 406 include parameters reception instructions 408 to receive, from a plurality of virtual compute entities, respective parameters indicative of how many virtual compute processes are in the virtual compute entities. The parameters can be received in communication channels between the virtual compute entities and a host processor manager including the scheduling instructions 406.

The scheduling instructions 406 include scheduling weights generation instructions 410 to generate a plurality of scheduling weights for the plurality of virtual compute entities based on a scheduling policy that considers the respective parameters and possibly one or more other factors. The plurality of scheduling weights include a first scheduling weight for a first virtual compute entity based on a first parameter indicative of a first quantity of virtual compute processes in the first virtual compute entity, and a second scheduling weight for a second virtual compute entity based on a second parameter indicative of a second quantity of virtual compute processes in the second virtual compute entity, where the second quantity is different from the first quantity.

The scheduling instructions 406 include processing resource shares allocation instructions 412 to allocate shares of a processing resource for the plurality of virtual compute entities based on the plurality of scheduling weights. The virtual compute entities and any processes that are not virtual compute entities can execute using respective allocated shares of the processing resource.

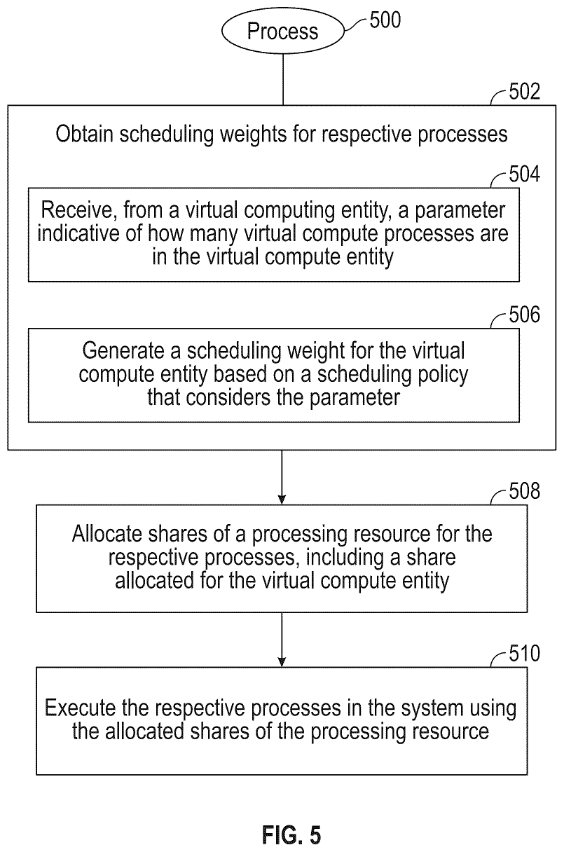

FIG. 5 is a flow diagram of a process 500 according to some examples of the present disclosure. The process 500 may be performed in the computing system 100 of FIG. 1, for example. The process 500 includes obtaining (at 502) scheduling weights for respective processes in the system, where the obtaining includes receiving (at 504), from a virtual compute entity, a parameter indicative of how many virtual compute processes are in the virtual compute entity, and generating (at 506) a scheduling weight for the virtual compute entity based on a scheduling policy that considers the parameter.

The process 500 includes allocating (at 508) shares of a processing resource for the respective processes, where the shares include a share of the processing resource allocated to the virtual compute entity based on the scheduling weight generated for the virtual compute entity based on the parameter.

The process 500 includes executing (at 510) the respective processes in the system using the allocated shares of the processing resource.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine readable storage medium comprising scheduling instructions that upon execution cause a system to:
receive, from a virtual compute entity, a parameter indicative of how many virtual compute processes are in the virtual compute entity;
generate a scheduling weight for the virtual compute entity based on a scheduling policy that considers the parameter; and
allocate a share of a processing resource for the virtual compute entity based on the scheduling weight.

2. The non-transitory machine readable storage medium of claim 1, wherein the parameter is a count of how many virtual compute processes are in the virtual compute entity.

3. The non-transitory machine readable storage medium of claim 1, wherein the parameter represents weights of the virtual compute processes in the virtual compute entity.

4. The non-transitory machine readable storage medium of claim 1, wherein the scheduling weight is generated based on an output of a function that uses the parameter.

5. The non-transitory machine readable storage medium of claim 4, wherein the function that uses the parameter to generate the scheduling weight is a logarithmic function.

6. The non-transitory machine readable storage medium of claim 1, wherein the parameter is received from the virtual compute entity in a communication channel between the virtual compute entity and a host process manager comprising the scheduling instructions.

7. The non-transitory machine readable storage medium of claim 6, wherein the virtual compute entity comprises a virtual machine (VM), and the host process manager comprises a hypervisor.

8. The non-transitory machine readable storage medium of claim 7, wherein the communication channel comprises a paravirtual channel.

9. The non-transitory machine readable storage medium of claim 7, wherein the communication channel is created responsive to a system call in the VM that triggers a privilege level transition in the VM.

10. The non-transitory machine readable storage medium of claim 1, wherein the parameter has a first value representing a first quantity of virtual compute processes in the virtual compute entity at a first time.

11. The non-transitory machine readable storage medium of claim 10, wherein the scheduling instructions upon execution cause the system to:
receive, from the virtual compute entity, the parameter having a second value representing a second quantity of virtual compute processes in the virtual compute entity at a second time, the second value being different from the first value;
generate a modified scheduling weight for the virtual compute entity based on the second value of the parameter; and
allocate a modified share of the processing resource for the virtual compute entity based on the modified scheduling weight.

12. The non-transitory machine readable storage medium of claim 1, wherein the scheduling instructions upon execution cause the system to:
allocate a further share of the processing resource to a process that is not a virtual compute entity, wherein the further share of the processing resource allocated to the process does not consider how many sub-processes are associated with the process.

13. The non-transitory machine readable storage medium of claim 1, wherein the share of the processing resource allocated for the virtual compute entity is a time slice of the processing resource allocated for the virtual compute entity.

14. A system comprising:
a hardware processor; and
a non-transitory storage medium storing scheduling instructions executable on the hardware processor to:
receive, from a plurality of virtual compute entities, respective parameters indicative of how many virtual compute processes are in the virtual compute entities;
generate a plurality of scheduling weights for the plurality of virtual compute entities based on a scheduling policy that considers the respective parameters, wherein the plurality of scheduling weights comprise a first scheduling weight for a first virtual compute entity based on a first parameter indicative of a first quantity of virtual compute processes in the first virtual compute entity, and a second scheduling weight for a second virtual compute entity based on a second parameter indicative of a second quantity of virtual compute processes in the second virtual compute entity, the second quantity being different from the first quantity; and
allocate shares of a processing resource for the plurality of virtual compute entities based on the plurality of scheduling weights.

15. The system of claim 14, wherein the allocating of the shares is performed during a scheduling period in which the scheduling instructions allocate shares of the processing resource to multiple processes including the plurality of virtual compute entities.

16. The system of claim 14, wherein each parameter of the parameters represents weights of virtual compute processes in a respective virtual compute entity.

17. The system of claim 16, wherein the first scheduling weight for the first virtual compute entity is based on a sum of weights of the virtual compute processes in the first virtual compute entity represented by the first parameter.

18. The system of claim 14, wherein the first scheduling weight for the first virtual compute entity is generated based on a logarithmic function applied to the first parameter, and the second scheduling weight for the second virtual compute entity is generated based on a logarithmic function applied to the second parameter.

19. A method comprising:
obtaining, by a system comprising a hardware processor, scheduling weights for respective processes in the system, wherein the obtaining comprises receiving, from a virtual compute entity, a parameter indicative of how many virtual compute processes are in the virtual compute entity, and generating a scheduling weight for the virtual compute entity based on a scheduling policy that considers the parameter;
allocating, by the system, shares of a processing resource for the respective processes, wherein the shares comprise a share of the processing resource allocated to the virtual compute entity based on the scheduling weight generated for the virtual compute entity based on the scheduling policy that considers the parameter; and
executing the respective processes in the system using the allocated shares of the processing resource.

20. The method of claim 19, wherein the parameter is a count of how many virtual compute processes are in a respective virtual compute entity or represents weights of the virtual compute processes in the virtual compute entity.
